(19) United States
(12) Patent Application Publication
(10) Pub. No.: US 2013/0094525 A1
(43) Pub. Date: Apr. 18, 2013

(54) MEMS Q-Switched Er:Yb:Glass Laser

(71) Applicants: John E. Nettleton, Fairfax Station, VA (US); Lew Goldberg, Fairfax, VA (US); Dallas N. Barr, Woodbridge, VA (US)

(72) Inventors: John E. Nettleton, Fairfax Station, VA (US); Lew Goldberg, Fairfax, VA (US); Dallas N. Barr, Woodbridge, VA (US)

(73) Assignee: United States of America, as represented by the Secretary of the Army, Fort Belvoir, VA (US)

(21) Appl. No.: 13/273,578

(22) Filed: Oct. 14, 2011

(51) Int. Cl. H01S 3/11

(52) U.S. Cl. 372/10

(57) ABSTRACT

The compact Er:Yb:Glass Laser Cavity incorporates all optical components required for a short-pulse laser. These optical components are ‘locked’ into alignment forming an optical laser cavity for diode laser or flash lamp pumping. The optical laser cavity does not need optical alignment after it is fabricated. The improvement upon the original Er:Yb:Glass design replaces the Cobalt Spinel passive Q-switch component with a MEMS active Q-Switch component.

### GOVERNMENT INTEREST

The invention described herein may be manufactured, used, sold, imported, and/or licensed by or for the Government of the United States of America.

### FIELD OF THE INVENTION

This invention relates in general to laser cavities, and more particularly to an Er:Yb:glass laser cavity capable of producing a short-pulse, eye safe laser.

### BACKGROUND OF THE INVENTION

Laser range finders are becoming an increasingly vital component in high precision targeting engagements. The precise and accurate range to target information is an essential variable to the fire control equation of all future soldier weapons. This information is easily, and timely, provided by laser range finders.

Unfortunately, current fielded laser range finders are bulky, heavy and expensive. These laser range finders were not developed with the individual soldier and his special needs in mind.

The Er:Yb:Glass Laser makes the development/fabrication of a very low cost, compact, short range laser range finder feasible. The Er:Yb:Glass laser converts the laser diode pump radiation directly to the desired eye safe wavelength of about 1530 nm (an Optical Parametric Oscillator is not needed!). The output laser of the Er:Yb:Glass is of generally good quality and thus requires minimum sized optics for adequate collimation of the beam for use in a laser range finder system.

### SUMMARY OF THE INVENTION

An Er:Yb:Glass laser cavity can be based on either an active or passive Q-Switch to emit at an eye safe wavelength, e.g., of 1533 nm. The Er:YB:Glass laser can be flash lamp pumped or pumped by laser diodes emitting radiation from about 930 nm to 980 nm.

More generally, a Q-switched laser cavity is disclosed. An exemplary Q-switched laser cavity comprises a Q-switch; an active laser medium based on a suitable laser material; and an output coupler. Such an output coupler is configured at an opposite end of said active laser medium to emit radiation along an optical axis of the laser cavity at its output end.

### BRIEF DESCRIPTION OF THE DRAWINGS

Additional advantages and features will become apparent as the subject invention becomes better understood by reference to the following detailed description when considered in conjunction with the accompanying drawings wherein:

FIG. 1 shows an Er:Yb:glass laser cavity based on a cobalt spinel Q-switch; and

FIG. 2 shows an exemplary embodiment of an Er:Yb:glass laser cavity based on a MEMS Q-switch.

### DETAILED DESCRIPTION

Exemplary Q-switched Er:Yb:glass laser embodiments are variously disclosed based on various alternative Q-switch components to improve the optical-to-optical efficiency. Such exemplary embodiments can provide output emission control of the Er:Yb:glass laser output pulse energy.

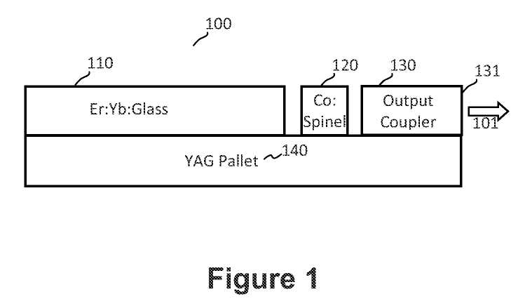

A laser cavity 100 as shown in FIG. 1 can be based on an Er:Yb:glass laser medium 110 disposed with respect to a Cobalt Spinel Passive Q-Switch 120 to emit at the eye safe wavelength, e.g., of 1533 nm. Although the active laser medium is disclosed as Er:Yb:Glass, any of the numerous suitable laser materials can also be used. An active laser medium such as the Er:YB:Glass laser can be flash lamp pumped or pumped by laser diodes emitting radiation from about 930 nm to 980 nm. As exemplified in FIG. 1, an Er:Yb:glass laser medium 110 is followed by a Co:Spinel Q-Switch 120. The Co:Spinel Q-Switch 120 is then followed by an output coupler 130 capable of emitting radiation 101 at the output end 131. Said laser components rest on a YAG pallet 140 as depicted in FIG. 1.

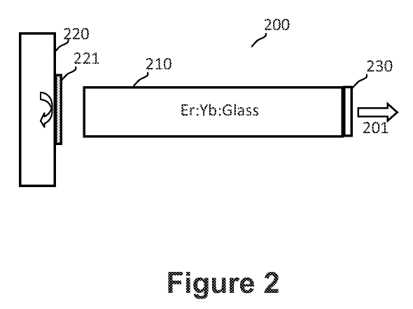

An alternative exemplary embodiment of an Er:Yb:Glass laser cavity is based on replacing the Cobalt Spinel Passive Q-Switch with a MEMS Scanner Active Q-Switch as shown in FIG. 2. As exemplified in FIG. 2, said MEMS Scanner Active Q-Switch 220 is followed by an active laser medium 210 disposed along an optical axis of the laser cavity 200 to have one end facing said Q-switch. Although the active laser medium is disclosed as Er:Yb:Glass, any of the numerous suitable laser materials can also be used. As shown in FIG. 2, an output coupler 230 is configured at an opposite end of said Er:Yb:glass laser medium 210 to emit radiation 201 along the optical axis of the laser cavity.

As exemplified in FIG. 2, the MEMS Scanner Active Q-Switch 220 is a resonant scanning device. Two commercially available scanners were tried with success. One scanner mirror is a single axis MEMS scanning mirror based on a reflective mirror (OPUS Microsystems® BA0050). An alternative scanner mirror is an SC-5 resonant optical scanner available from Electro-Optical Products Corp. The disclosure encompasses those and any such commercially available scanning mirror suitable for use as a Q-switch when referring to a scanner-based Q-switch, a MEMS scanner or a MEMS mirror. The scanning mirror 221 is swept back and forth along an optical axis of the laser cavity in the direction of the laser energy emission 201. When the MEMS scanning mirror 221 is not aligned with the output coupler 230 no lasing can occur, the lasing action is held off. But during a sweep or cycle of the mirror, the MEMS mirror will precisely align with the output coupler 230 and cause the built-up laser energy to emit 201 in a short pulse. There is no loss (blockage) of the laser during the Q-switching like there is in the Co:Spinel Passive Q-Switch case (e.g., FIG. 1). This lossless Q-switch operation leads to very efficient optical-to-optical output of the laser.

The resonant frequency of the MEMS scanner 220 is selected based on the allowable pump time (approximately the florescence lifetime of the gain media). The period of the resonant frequency should be longer than the pump time. For example, the Er:Yb:Glass laser cavity uses Er:Yb:Glass as the gain media and has a florescence lifetime of about 4 milli-seconds which leads to a MEMS scanner resonant frequency of 250 Hz or less.

The Pump will be synchronized with the MEMS Scanner Active Q-Switch which provides an electronic signal, such as a sine wave, that is correlated to the mirror position. The pump will begin at the precise time before the MEMS mirror reaches the Q-Switch position (parallel with the output coupler).

Side pumping with flash tamp or laser diodes can be accomplished for any of the exemplary embodiments. End pumping with laser diodes requires use of a dichroic beam splitter.

A filtered photodetector tuned to the laser wavelength of the cavity (e.g., about 1530 nm for the Er:Yb:Glass) which tracks the florescence building up inside the cavity, can also be added. This photodetector can provide optical feedback to allow for control of the final output laser emission over temperature extremes for any of the exemplary embodiments.

### ADVANTAGES

The variously described exemplary embodiments improve the optical efficiency of the monoblock laser and allows active control of the output laser emission (pulse energy). The MEMS Scanner Active Q-Switch also has the potential of being much less costly than the Cobalt Spinel Passive Q-switch. Such an active Q-switch can be packaged as an electronic chip, in contrast to a semi-precious, grown laser crystal being used as a passive Q-switch.

The Improved Er:Yb:Glass Laser Cavity is still a simple module that requires none of the labor extensive alignment procedures as current laser range finder solid state sources. No optical holders have to be fabricated, no complex engineering is required to design the optical cavity, and no precise laser cavity alignment(s) are required. Production labor and material costs are greatly reduced.

The Improved Er:Yb:Glass Laser Cavity is a modular component. The modularity lends to ease of design for different pump sources. It can be incorporated in a flash lamp pumped or laser diode pumped system.

### APPLICATIONS

The variously described exemplary embodiments may be used as the laser source in very compact laser range finders. The Er:Yb:Glass generates eye safe laser output for eye safe laser range finding. These laser range finders have both military and commercial applications. The compact design of the Improved Er:Yb:Glass Laser Cavity also lends itself to placement in other laser-based portable/hand-held devices. These may be medical devices, industrial tools or scientific equipment that would benefit from the size/weight reduction, dependable performance, and low cost.

It is obvious that many modifications and variations of the present invention are possible in light of the above teachings. It is therefore to be understood that within the scope of the appended claims, the invention may be practiced otherwise than as described.

What is claimed is:

1. A Q-switched laser cavity, comprising:
a Q-switch;
an active laser medium based on a suitable laser material; and
an output coupler configured to emit radiation along an optical axis of the laser cavity at its output end.

2. The Q-switched laser cavity according to claim 1, wherein said active laser medium is an Er:Yb:glass laser medium, wherein said Q-switch is a cobalt spinet passive Q-switch arranged between said active laser medium and said output coupler, and wherein said active laser medium, said Q-switch and said output coupler are disposed as optical components in an arrangement along said optical axis of the laser cavity on a YAG pallet.

3. The Q-switched laser cavity according to claim 2, wherein the fluorescence lifetime of an Er:Yb:glass laser medium is about 4 milliseconds, and wherein said Er:Yb:glass laser medium can be flash lamp pumped or pumped by laser diodes emitting radiation from about 930 nm to 980 nm.

4. The Q-switched laser cavity according to claim 3, wherein said flash lamp pumping or pumping by laser diodes can be side pumped, or alternatively end pumped with the use of a dichroic beam splitter.

5. The Q-switched laser cavity according to claim 1, wherein filtered photodetection can be tuned to a laser wavelength to track the florescence build up inside the cavity and provide optical feedback to allow for control of the output laser emission over temperature extremes.

6. The Q-switched laser cavity according to claim 5, wherein said filtered photodetection is tuned to the laser wavelength of about 1530 nm for the Er:Yb:glass laser cavity for control of the output laser emission over a temperature range.

7. The Q-switched laser cavity according to claim 1, wherein said Q-switch is an active Q-switch, said active laser medium is an Er:Yb:glass laser medium disposed along the optical axis of the laser cavity to have one end facing said Q-switch, and said output coupler is configured at an opposite end of said Er:Yb:glass laser medium to emit radiation along the optical axis of the laser cavity at said output end.

8. The Q-switched laser cavity according to claim 7, wherein the fluorescence lifetime of an Er:Yb:glass laser medium is about 4 milliseconds, and wherein said Er:Yb:glass laser medium can be flash lamp pumped or pumped by laser diodes emitting radiation from about 930 nm to 980 nm.

9. The Q-switched laser cavity according to claim 8, wherein said flash lamp pumping or pumping by laser diodes can be side pumped, or alternatively end pumped with the use of a dichroic beam splitter.

10. The Q-switched laser cavity according to claim 7, wherein said Q-switch is based on either a MEMS scanner or a resonant optical scanner having a resonant mirror end facing said one end opposite to said output end such that a mirror of said scanner resonates to act as an active Q-switch.

11. The Q-switched laser cavity according to claim 10, wherein said mirror resonates by sweeping back and forth along the optical axis of the laser cavity, wherein the mirror precisely aligning with the output coupler during a sweep causes a build-up of laser energy to emit in a short pulse without blockage.

12. The Q-switched laser cavity according to claim 10, wherein the resonant frequency of the scanner is selected based on an allowable pump time.

13. The Q-switched laser cavity according to claim 10, wherein an electronic signal, such as a sine wave, is correlated to the mirror position such that a pump can begin at the precise time before the scanner mirror faces the optical axis.

14. The Q-switched laser cavity according to claim 10, wherein said MEMS scanner is packaged as an electronic chip, and wherein a precise laser cavity alignment is not necessary.

15. The Q-switched laser cavity according to claim 10, wherein said Q-switched laser cavity is a modular component capable of interfacing with a pump source, incorporation in a flash lamp pumped system, or incorporation in a laser diode pumped system.

16. A compact laser range finder having Q-switched laser cavity according to claim 10 as its laser source.

17. A portable or hand-held laser device based on said Q-switched laser cavity according to claim 10, wherein said laser device is for medical, industrial or scientific applications where size/weight reduction, dependable performance, and/or low cost are design considerations.
